(19) United States
(12) Patent Application Publication
(10) Pub. No.: US 2025/0240096 A1
(43) Pub. Date: Jul. 24, 2025

(54) DEVICE AND METHOD FOR INTEGRATED SENSING AND COMMUNICATION

(71) Applicant: HUAWEI TECHNOLOGIES CO., LTD., Shenzhen (CN)

(72) Inventors: Hanwen Cao, Munich (DE); Anh Vu Vu, Munich (DE); Mohamed Gharba, Munich (DE); Josef Eichinger, Munich (DE)

(73) Assignee: HUAWEI TECHNOLOGIES CO., LTD., Shenzhen (CN)

(21) Appl. No.: 19/176,833

(22) Filed: Apr. 11, 2025

Related U.S. Application Data
(63) Continuation of application No. PCT/EP2022/078237, filed on Oct. 11, 2022.

(51) Int. Cl. H04B 10/116; H04B 10/54; H04B 10/60

(52) U.S. Cl. CPC H04B 10/116; H04B 10/541; H04B 10/60

(57) ABSTRACT

This disclosure relates to optical wireless communications. An optical signal transmitter is provided to transmit a hybrid optical signal. The hybrid optical signal comprises low-rate assistance information and high-rate data. The low-rate assistance information comprises a transmitter ID. The high-rate data is carried via a high-frequency optical signal. The low-rate assistance information is carried via a low-frequency on-off pattern during the transmission of the high-frequency optical signal. During each on period, the transmitter transmits the high-frequency optical signal; while during each off period, the transmitter pauses transmitting the high-frequency optical signal. In this way, the on-off pattern can be detected and decodable by an image sensor of a corresponding optical signal receiver. The receiver may be aware of the transmitter ID and can associate the transmitter ID with the positioning of the corresponding transmitter. In this way, sensing and optical wireless communication can be achieved via a single hybrid signal.

### CROSS-REFERENCE TO RELATED APPLICATIONS

This is a continuation of International Patent Application No. PCT/EP2022/078237, filed on Oct. 11, 2022, the disclosure of which is hereby incorporated by reference in its entirety.

### TECHNICAL FIELD

The present disclosure generally relates to the field of wireless communications. For example, this disclosure presents optical devices and methods for optical wireless communication (OWC), such as integrated sensing and communications with optical wireless (ISAC-OW).

### BACKGROUND

In a next-generation wireless communications technology, such as the sixth generation (6G) wireless networks, sensing and communications functions can be integrated. Among high frequency bands and in addition to millimeter wave (mmWave), 6G can further utilize terahertz (THz) and even optical spectrum.

ISAC-OW technology can be integrated into existing lighting and light display systems, e.g. making every lamp and every screen part of the ISAC-OW system. Given the ultra-high communication bandwidth, ISAC-OW is also a potential candidate to achieve ultra-high throughput. Moreover, ISAC-OW has an almost unlimited amount of spectrum. Because of the gap between optical spectrum and conventional electromagnetic spectrum, there will be no mutual electromagnetic interference between optical wireless (OW) device and conventional radio frequency (RF) device. ISAC-OW is especially suitable for electromagnetic radiation-sensitive environments, such as smart healthcare, aviation, and industrial manufacturing. Further, ISCA-OW can increase information security and is resilient to eavesdropping and jamming. ISCA-OW is also applicable for wireless charging.

The microwave level or sub-micrometer level wavelength of the optical spectrum can enable high-precision positioning and high-resolution imaging, which, when combined with the response of substances to the characteristics of light waves, will enable more precise and accurate health sensing and monitoring.

### SUMMARY

In a conventional ISAC-OW network, it is still not clear how to coordinate high-speed data transmission and high-precision positioning. A light detector on an OW-AP, such as a photodiode (PD) which is mainly used for communication, can receive optical signals with high data rate. But the light detector cannot sense the position of an object (e.g., a terminal) with high precision or reliably. On the contrary, an image sensor of an OW sensor, or a calibrated system of stereo/multiple image sensors, which are used mainly for OW sensing, can sense objects of high accuracy. However, the image sensor typically has a limited (and/or fixed) frame rate (e.g. due to hardware limitations) and therefore cannot properly capture optical signals of high data rate (or bandwidth). Typically, the OW sensing and communication are treated as separate applications and are provided with conventional solutions in a separate manner. However, the position information of the terminal, in particular the angular information of the terminal (or more specifically, the angular information of the communication components of the terminal), is critical for establishing and/or maintaining high-speed data transmission in a high-reliability manner, e.g. via beam-based optical wireless communication, as well as via beam-based RF communication. That is, the identity and the position information of the terminal needs to be timely transmitted (or sensed). The angular information of the terminal may comprise one or more angles of the terminal's location referring to the position of the image sensor. For instance, the one or more angles may comprise one or more of yaw, pitch, and roll. In some cases, the angular information may be represented using polar coordinate system. In this disclosure, the OW sensing may be referred to as device (or terminal) identification and positioning.

In view of the above, this disclosure generally aims at achieving a unified ISAC-OW network architecture. For example, one objective is to provide a unified solution for signal modulation that enables both OW sensing and communication. A further objective may be to enable the modulated signal to be transmitted by a single optical component (e.g., light emitting diode (LED) or superluminescent diode (SLD)) and to be capturable (or detectable) by both high-speed data receiver (e.g., a PD) and sensing receiver (e.g., an image sensor).

These and other objectives are achieved by this disclosure, for instance, as described in the independent claims. Advantageous implementations are further described in the dependent claims.

A first aspect of this disclosure provides an optical signal transmitter for an optical wireless communication system. In this disclosure, unless specified otherwise, the optical signal transmitter may be simply referred to as a transmitter, or a terminal as an example. Likewise, an optical signal receiver in this disclosure may be simply referred to as a receiver, or an AP as an example.

The transmitter is configured to transmit a high-frequency optical signal carrying high-rate data at a first frequency (e.g., to a receiver). For transmitting the high-frequency optical signal, the optical signal transmitter is configured to determine an on-off pattern comprising multiple on periods and multiple off periods at a second frequency. The transmitter is configured to transmit the high-frequency optical signal during the on periods; and pause transmitting the high-frequency optical signal during the off periods. The first frequency is higher than the second frequency. The on-off pattern represents a low-frequency signal that carries low-rate assistance information, wherein the assistance information comprises an identity of the transmitter.

The term “pause transmitting” may be understood as “not to transmit” or “halt the transmission of”. The term “represents” herein may be understood as “characterizes” or “is coded as”. The term “carries” herein may be understood as “is modulated with”.

In this way, a single optical signal transmitter may utilize a hybrid optical signal for both high-speed optical wireless communications and sensing. Moreover, the optical wireless sensing and communications may be unified into a single system, and there is no need to have separated systems with redundant components for OW sensing and communications, respectively.

In an implementation form of the first aspect, the assistance information may comprise one or more of the following:
motion-related information of the transmitter;
encryption key information of the transmitter; and
a resource request.

Optionally, the motion-related information may comprise a moving speed and/or direction of the transmitter. This can be used for improving sensing (e.g. positioning) and communication performance.

Optionally, the encryption key information may comprise a public key of the transmitter. The public key corresponds to a private key, which is only known to the transmitter. The receiver, after obtaining the public key, can perform encryption based on the public key. For example, the communication channel from the receiver to the transmitter can be encrypted using the public key. The transmitter can use the corresponding private key to decrypt data. In this way, communication encryption can be achieved and the security level of the OW communication can be enhanced.

Optionally, the resource request may be used to indicate a subsequent (or future) uplink data transmission, such as pending data in an uplink channel (e.g. time-frequency resource). The subsequent uplink data may be part of the high-rate data. In this way, the receiver can obtain subsequent data according to the resource request. In this way, the transmitter can flexibly and autonomously arrange resources for transmitting the high-rate data.

In an implementation form of the first aspect, the transmitter may be further configured to adapt the second frequency to a sampling rate of an image sensor of an optical signal receiver receiving the high-frequency optical signal.

Optionally, the transmitter may be informed in advance about the sampling rate of the image sensor of the optical signal receiver (in the following simply referred to as “the sampling rate of the receiver”). For instance, the sampling rate of the receiver may be prescribed, e.g., in a standard or a specification that is followed by the transmitter and the receiver. Alternatively, the receiver may send information about the sampling rate to the transmitter in advance. For a further instance, the sampling rate may be pre-set in the transmitter, e.g., manually input by a user who is aware of the sampling rate of the receiver.

In an implementation form of the first aspect, the transmitter may be further configured to transmit one or more dummy optical signals when no high-rate data is transmitted during one or more of the on periods.

Optionally, the dummy optical signal may be on the same frequency as the high-frequency optical signal, i.e., the first frequency. The dummy optical signal may be just used for padding and may not carry any meaningful data.

The term “when” herein shall be understood as “during a period of”.

Optionally, during at least one on period of the multiple on periods, the transmitter may be configured to transmit a combination of the high-frequency optical signal and the one or more dummy optical signals.

In this way, the low-frequency signal can still be properly represented by the on-off pattern even in the case that there is no sufficient high-rate data to be transmitted.

In an implementation form of the first aspect, the high-frequency optical signal may further carry a copy of the assistance information.

Optionally, the copy of the assistance information may be used for verification and/or recovery if necessary. In this way, the reliability of the assistance information transmission can be increased.

In an implementation form of the first aspect, the transmitter may be further configured to modulate the assistance information based on the on-off pattern.

Optionally, any modulation based on the on-off pattern may be used, such as but not limited to: on/off keying, pulse position modulation, and color shift keying.

In an implementation form of the first aspect, the transmitter may be configured to transmit more than one high-frequency optical signal using carriers of different wavelengths, wherein the carriers of different wavelengths correspond to different on-off patterns.

In an implementation form of the first aspect, the transmitter may be an optical wireless terminal, or at least a part of the optical wireless terminal.

A second aspect of the present disclosure provides an optical signal receiver for an optical wireless communication system. The optical signal receiver comprises at least one light detector and at least one image sensor.

The image sensor is configured to detect a high-frequency optical signal sent from an optical signal transmitter, and determine an on-off pattern at a second frequency comprising multiple on periods and multiple off periods by successfully detecting the high-frequency optical signal during the multiple on periods, and by not having detected the high-frequency optical signal during the multiple off periods.

The image sensor is configured to obtain a low-frequency signal that carries low-rate assistance information based on the on-off pattern, obtain an identity of the optical signal transmitter comprised in the assistance information, and obtain location information of the optical signal transmitter.

The light detector is configured to receive the high-frequency optical signal transmitted at a first frequency based on the identity and the location information of the optical signal transmitter. The first frequency is higher than the second frequency.

Optionally, the image sensor may be with or without optical lens. In case the image sensor is equipped with an optical lens, various optical lenses may be used such as but not limited to: wide angle, standard and telephoto lenses for sensing different ranges, angles, and objects. Optionally, the optical lens may change the focal length to focus on a tracked (sensed) object.

The receiver according to this disclosure can obtain the identity of the optical signal transmitter and receive the high-rate data based on a same optical wireless signal. The same optical wireless signal is also used for sensing. In this way, sensing and high-speed communication can be jointly unified, and simplified system architecture can be achieved. Moreover, the transmitter's location (or position) associated with the identity of the transmitter can be used by the receiver to enhance beam tracking and power control. In this way, communication performance can be improved.

In an implementation form of the second aspect, the optical signal receiver may be further configured to obtain motion-related information of the optical signal transmitter comprised in the assistance information.

In this way, the optical signal receiver may increase the positioning precision for an optical signal transmitter that is moving.

In an implementation form of the second aspect, the optical signal receiver may be further configured to obtain encryption key information comprised in the assistance information, and perform encryption based on the encryption key information.

Optionally, the encryption key information comprises a public key of the transmitter. The receiver may be further configured to encrypt data that is sent by the receiver to the transmitter using the public key. The transmitter has a corresponding private key for decryption. In this way, encrypted communication can be achieved, and the security level of the communication can be increased.

In an implementation form of the second aspect, the optical signal receiver may be further configured to obtain a resource request comprised in the assistance information, and receive further data based on the resource request.

Optionally, the resource request is used to indicate a subsequent (or future) uplink data transmission, such as pending data in an uplink channel (e.g. time-frequency resource). The subsequent uplink data may be part of the high-rate data. In this way, the receiver can obtain subsequent data according to the resource request. In this way, the transmitter can flexibly arrange resources for transmitting the high-rate data.

In an implementation form of the second aspect, the optical signal receiver may be configured to determine the second frequency based on a sampling rate of the image sensor.

Optionally, the second frequency may be less than or equal to half of the sampling rate.

In an implementation form of the second aspect, the image sensor may be further configured to capture sensing data associated with the high-frequency optical signal. The optical signal receiver may be further configured to obtain the location information of the optical signal transmitter based on the sensing data, and associate the determined location information with the identity of the optical signal transmitter. The light detector is configured to receive the high-frequency optical signal based further on the determined location information of the optical signal transmitter.

In an implementation form of the second aspect, the optical signal receiver may be further configured to determine a pixel region of the image sensor where the assistance information is received, and determine the location information of the optical signal transmitter based further on the pixel region.

In an implementation form of the second aspect, the optical signal receiver may be further configured to:
obtain distance and/or depth information of the optical signal transmitter from the image sensor, and
determine the position of the optical signal transmitter based further on the distance and/or depth information.

In an implementation form of the second aspect, the optical signal receiver may be an optical wireless access point.

Optionally, the optical signal receiver may be capable of both OW sensing and at least optical communication. For instance, the optical signal receiver may be further capable of RF communication.

More generally, the optical signal receiver may comprise at least a network device for an optical wireless network (or referred to as an “OW network device”). For instance, the optical signal receiver may comprise distributed components (e.g., the light detector, the image sensor, AP, and/or any processing unit) deployed on the network side of the optical wireless network.

A third aspect of the present disclosure provides a method for transmitting a high-frequency optical signal for an optical wireless communication system (or optical wireless network). The high-frequency optical signal carries high-rate data at a first frequency. For transmitting the high-frequency optical signal, the method comprises the following steps:
determining, by an optical signal transmitter, an on-off pattern comprising multiple on periods and multiple off periods at a second frequency;
transmitting, by the optical signal transmitter, the high-frequency optical signal during the on periods; and
pause transmitting, by the optical signal transmitter, the high-frequency optical signal during the off periods.

The first frequency is higher than the second frequency. The on-off pattern represents a low-frequency signal that carries low-rate assistance information, wherein the assistance information comprises an identity of the optical signal transmitter.

In an implementation form of the third aspect, the assistance information may comprise one or more of the following:
motion-related information of the transmitter;
encryption key information of the transmitter; and
a resource request.

In an implementation form of the third aspect, the method may further comprise adapting, by the optical signal transmitter, the second frequency to a sampling rate of an image sensor of an optical signal receiver receiving the high-frequency optical signal.

In an implementation form of the third aspect, the method may further comprise transmitting, by the optical signal transmitter, one or more dummy optical signals when no high-rate data is transmitted during one or more of the on periods.

In an implementation form of the third aspect, the high-frequency optical signal may further carry a copy of the assistance information.

In an implementation form of the third aspect, the method may further comprise modulating, by the optical signal transmitter, the assistance information based on the on-off pattern.

In an implementation form of the third aspect, the method may further comprise transmitting, by the optical signal transmitter, more than one high-frequency optical signal using carriers of different wavelengths. The carriers of different wavelengths correspond to different on-off patterns.

In an implementation form of the third aspect, the optical signal transmitter may be an optical wireless terminal, or at least a part of the optical wireless terminal.

The method of the third aspect and its implementation forms may achieve the same advantages and effects as described above for the optical signal transmitter of the first aspect and its implementation forms.

A fourth aspect of the present disclosure provides a method for receiving a high-frequency optical signal for an optical wireless communication system. The method comprises the following steps:
detecting, by at least one image sensor of an optical signal receiver, a high-frequency optical signal sent from an optical signal transmitter,
determining, by the at least one image sensor of the optical signal receiver, an on-off pattern at a second frequency comprising multiple on periods and multiple off periods by successfully detecting the high-frequency optical signal during the multiple on periods, and by not having detected the high-frequency optical signal during the multiple off periods;
obtaining, by the optical signal receiver, a low-frequency signal that carries low-rate assistance information based on the on-off pattern;
obtaining, by the optical signal receiver, an identity of the optical signal transmitter comprised in the assistance information; and
receiving, by at least one light detector of the optical signal receiver, the high-frequency optical signal transmitted at a first frequency based on the identity of the optical signal transmitter.

The first frequency is higher than the second frequency.

In an implementation form of the fourth aspect, the method may further comprise obtaining, by the optical signal receiver, motion-related information of the optical signal transmitter comprised in the assistance information.

In an implementation form of the fourth aspect, the method may further comprise:
obtaining, by the optical signal receiver, encryption key information comprised in the assistance information, and
performing, by the optical signal receiver, encryption based on the encryption key information.

In an implementation form of the fourth aspect, the method may further comprise:
obtaining, by the optical signal receiver, a resource request comprised in the assistance information, and
receiving, by the optical signal receiver, further data based on the resource request.

In an implementation form of the fourth aspect, the method may further comprise determining, by the optical signal receiver, the second frequency based on a sampling rate of the image sensor.

In an implementation form of the fourth aspect, the method may further comprise:
capturing, by the image sensor, sensing data associated with the high-frequency optical signal;
obtaining, by the optical signal receiver, the location information of the optical signal transmitter based on the sensing data,
associating, by the optical signal receiver, the determined position with the identity of the optical signal transmitter; and
receiving, by the light detector, the high-frequency optical signal based further on the determined position of the optical signal transmitter.

In an implementation form of the fourth aspect, the method may further comprise:
determining, by the optical signal receiver, a pixel region of the image sensor where the assistance information is received, and
determining, by the optical signal receiver, the position of the optical signal transmitter based further on the pixel region.

In an implementation form of the fourth aspect, the method may further comprise:
obtaining, by the optical signal receiver, distance and/or depth information of the optical signal transmitter from the image sensor, and
determining, by the optical signal receiver, the position of the optical signal transmitter based further on the distance and/or depth information.

In an implementation form of the fourth aspect, the optical signal receiver may be an optical wireless access point.

The method of the fourth aspect and its implementation forms may achieve the same advantages and effects as described above for the optical signal receiver of the second aspect and its implementation forms.

A fifth aspect of the present disclosure provides a system comprising at least one optical signal transmitter according to the first aspect or any of its implementation forms, and at least one optical signal receiver according to the second aspect or any of its implementation forms.

A sixth aspect of the present disclosure provides a computer program product comprising instructions which, when the program is executed by a computer, cause the computer to perform the method according to the third aspect or any of its implementation forms.

A seventh aspect of the present disclosure provides a non-transitory storage medium storing executable program code which, when executed by a processor, causes the method according to the third aspect or any of its implementation forms to be performed.

An eighth aspect of the present disclosure provides a chipset comprising a memory and a processor, which are configured to store and execute program code to perform the method according to the third aspect or any of its implementation forms.

A ninth aspect of the present disclosure provides a computer program product comprising instructions which, when the program is executed by a computer, cause the computer to perform the method according to the fourth aspect or any of its implementation forms.

A tenth aspect of the present disclosure provides a non-transitory storage medium storing executable program code which, when executed by a processor, causes the method according to the fourth aspect or any of its implementation forms to be performed.

An eleventh aspect of the present disclosure provides a chipset comprising a memory and a processor, which are configured to store and execute program code to perform the method according to the fourth aspect or any of its implementation forms.

It has to be noted that all devices, elements, units and means described in the present disclosure could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description in relation to the enclosed drawings, in which

FIG. 1 shows an example of a hybrid signal according to this disclosure;

FIG. 2 shows another example of a hybrid signal according to this disclosure;

FIG. 3 shows examples of an optical signal transmitter and an optical signal receiver according to this disclosure;

FIG. 4 shows an example of an optical signal transmitter according to this disclosure;

FIG. 5 shows an example of an optical signal receiver according to this disclosure;

FIG. 6 shows an example of a system according to this disclosure;

FIG. 7 shows an RF antenna array according to this disclosure;

FIG. 8 shows an application scenario of this disclosure;

FIG. 9 shows a diagram of a method according to this disclosure; and

FIG. 10 shows a diagram of a further method according to this disclosure.

### DETAILED DESCRIPTION OF EMBODIMENTS

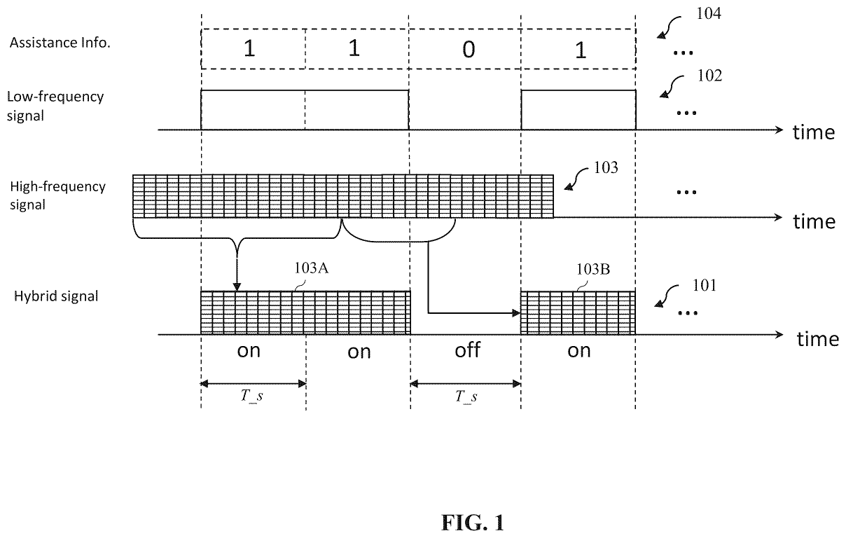

FIG. 1 shows an example of a hybrid signal 101 (transmitted by an optical signal transmitter) according to this disclosure. Correspondingly, the hybrid signal 101 is received by an optical signal receiver according to this disclosure.

The optical signal transmitter is configured to transmit a to-be-transmitted high-frequency optical signal 103 carrying high-rate data at a first frequency to an optical signal receiver. For transmitting the to-be-transmitted high-frequency optical signal 103, the optical signal transmitter is configured to determine an on-off pattern comprising multiple on periods and multiple off periods at a second frequency. The on-off pattern represents a low-frequency signal 102 that carries low-rate assistance information 104. It is noted that the data rate of the low-rate assistance information 104 is lower than that of the high-rate data. The term “represents” herein may be understood as “is coded as”. The term “carries” herein may be understood as “is modulated with”. The high-rate data may be referred to as user-related data that is to be communicated between the optical signal transmitter and receiver, or any OW communication data. The user-related data may be, for example, but not limited to, user-generated data, or application data intended for the user.

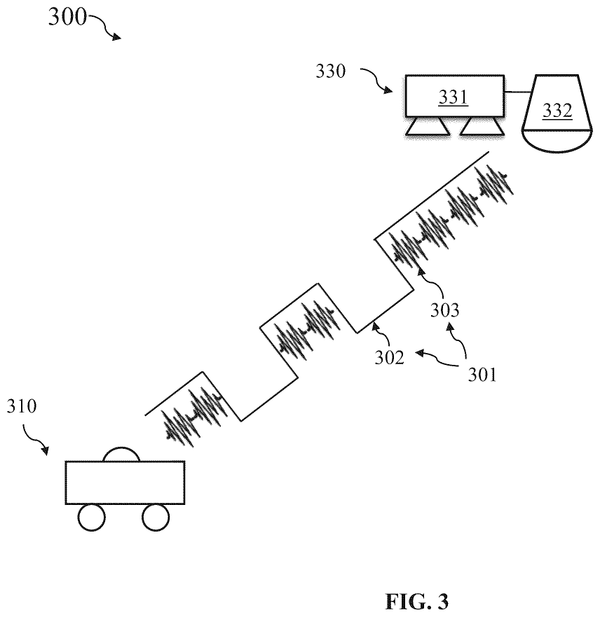

The optical signal transmitter is configured to transmit the high-frequency optical signal 103 during the on periods (or during each of the on periods); and pause transmitting the high-frequency optical signal 103 during the off periods (or during each of the off periods). It is noted that in FIG. 3, the high-frequency optical signal 103 is schematically illustrated as a to-be-transmitted high-frequency optical signal 103 (or simply, high-frequency signal 103). The to-be-transmitted high-frequency signal 103 is transmitted by the optical signal transmitter during each on period and is not transmitted by the optical signal transmitter during each off period. As a result, the to-be-transmitted high-frequency optical signal 103 may be segmentally transmitted as segmented high-frequency optical signals 103A, 103B, which are part of the to-be-transmitted high-frequency optical signal 103. In this way, the optical signal transmitter is configured to transmit a hybrid signal 101 that comprises the low-rate assistance information 104 and the high-rate data. The low-rate assistance information 104 is carried via the on-off pattern (or the envelope) of the hybrid signal, while the high-rate data is carried via the high-frequency optical signal 103A, 103B transmitted during each on period.

For controlling the on and off periods, the optical signal transmitter may be configured to use any means known in the field to achieve the on-off pattern. For instance, in a case where the optical signal transmitter may comprise an illumination unit adapted to transmit the high-rate data using an optical signal of the first frequency, the optical signal transmitter may be configured to turn on the illumination unit during each on period, and (temporarily) turn off illumination during each off period. It is noted that in alternative to turning off the illumination during each off period, the optical signal transmitter may be configured to dim the illumination below a certain threshold during each off period.

The multiple on periods and off periods at the second frequency forms the on-off pattern or the envelope of the optical signal transmitted by the transmitter. The on-off pattern may be used to carry information. The first frequency is higher than the second frequency. The first frequency may be any frequency where the optical wireless communication is operatable. For example, the first frequency may be in a range of infrared (IR), visible light, or ultraviolet (UV). In this disclosure, the on-off pattern represents (or characterizes) a low-frequency signal 102. The low frequency (second frequency) of the low-frequency signal 102 may correspond to the second frequency. The duration of each on period and each off period may be the same, e.g., being equal to T_s. The low frequency may be equal to 1/T_s.

The low-frequency signal 102 is used to carry the assistance information 104. The low frequency of the low-frequency signal 102 may be adapted to a sampling rate (or frame rate) of an image sensor of the optical signal receiver in order to be detectable by the image sensor. For example, due to Nyquist sampling criterion, the low frequency may be less than or equal to half of the sampling rate, so that the assistance information 104 carried by the low-frequency signal 102 can be properly recovered (decoded). As an example, the sampling rate of the image sensor may normally be up to thousands of frames per second (FPS). However, it shall be noted that the frame rate may depend on the hardware capability of the image sensor, and the sampling rate shall not be limited to the values or ranges given in this disclosure. Any suitable image sensor may be used, which may include consumer-grade image sensors (which may provide up to 240 FPS), and industry-grade image sensors with high frame rates (e.g., high-speed image sensors).

The low frequency may be prescribed in a standard or technical specification that is adopted by the optical signal transmitter and receiver. That is, the low frequency (or a possible list for selecting the low frequency) may be pre-determined or preset among the optical signal transmitter and receiver. Alternatively, the optical receiver may send indication information about the low frequency in a downlink channel (or in a broadcast channel) to each connectable optical signal transmitter, including said optical signal transmitter.

The assistance information 104 comprises an ID (e.g., a MAC/IP address, hardware number, or serial number) of the optical signal transmitter (hereinafter, the transmitter ID or the terminal ID). The transmitter ID may be used to uniquely identify the optical signal transmitter in the optical wireless communication system. In this disclosure, any unique value that can be used to uniquely identify the optical signal transmitter can be used as the transmitter ID.

In this disclosure, the optical signal transmitter may be an optical wireless terminal, the optical signal receiver may be at least a part of an optical wireless network device, such as an optical wireless access point (AP) integrated with at least one image sensor. The term “integrated” herein may be understood as that the optical AP may comprise the image sensor as an internal unit, or the optical AP is attached to the image sensor (e.g., via wired or wireless connections). In this disclosure, the optical signal transmitter may be referred to as a terminal as an example, the optical signal receiver may be referred to as an AP or an OW AP as an example.

Optionally, the assistance information 104 may further comprise one or more of the following information:
motion-related information of the optical signal transmitter (e.g. moving speed and/or direction), which can be used for improving sensing (e.g. positioning) and communication performance;
encryption key information (e.g. a public key of the optical signal transmitter), which can be used to encrypt the data sent to the optical signal transmitter by the optical signal receiver (e.g. downlink data from the OW AP to the terminal); and
resource request, which can be used to indicate a subsequent (or future) uplink data transmission, such as pending data in an uplink channel (e.g. time-frequency resource).

Optionally, the high-rate data may comprise the assistance information as a copy, which can increase the reliability of the assistance information transmission. The assistance information comprised in the high-rate data as a copy may be used for verification, authentication, and/or recovery.

The optical signal transmitter may be further configured to modulate the assistance information based on the on-off pattern. Any suitable modulation scheme that can achieve the on-off pattern can be applied, such as but not limited to: amplitude modulation (AM), amplitude-shift keying (ASK), and pulse modulation. For another example, any optical intensity-based modulation may be applied, such as on-off keying modulation, or variable pulse position modulation (VPPM). Color shift keying may also be used, e.g. in multi-carrier cases. One aspect of the disclosure provides a hybrid optical signal 101. The hybrid optical signal 101 comprises multiple on periods and multiple off periods at a second frequency. Each on period comprises at least a part of a high-frequency optical signal at a first frequency; each off period does not comprise the high-frequency optical signal or any part thereof. The high-frequency optical signal carries high-rate data. The multiple on periods and the multiple off periods form an on-off pattern at the second frequency. The first frequency is higher than the second frequency. The on-off pattern (or the envelope) of the hybrid optical signal 101 represents a low-frequency signal. The low-frequency signal carries (e.g., is modulated with) low-rate assistance information, which comprises an identity of an optical signal transmitter transmitting the hybrid optical signal.

In this way, the hybrid signal, which is a single OW signal transmitted by a single transmitter, can be used for both high-speed OW communication and sensing. Therefore, the efficiency and simplicity of OW communications can be improved. There is no need to use additional/separate signaling for sensing between the optical signal transmitter and receiver.

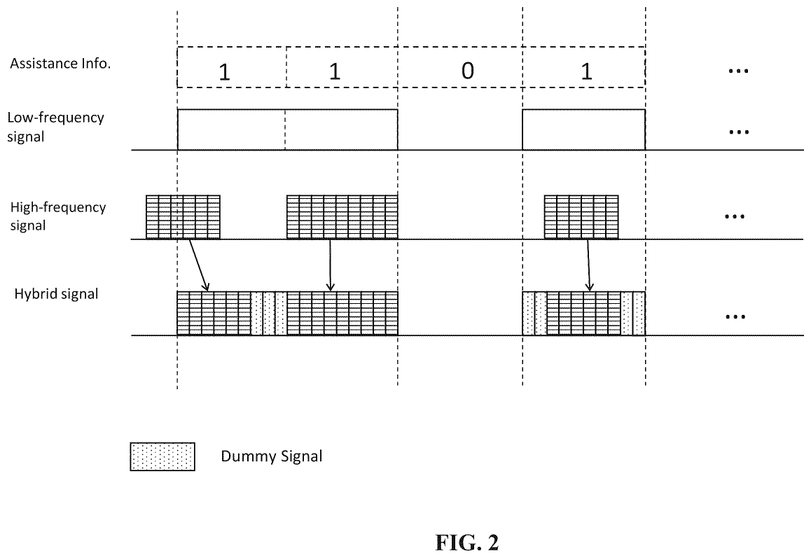

FIG. 2 shows another example of a hybrid signal (transmitted by an optical signal transmitter) according to this disclosure. Corresponding elements in FIGS. 1 and 2 may share the same features and function likewise.

In FIG. 2, during each on period, the optical signal transmitter may be configured to transmit one or more dummy signals when there is no high-rate data to be transmitted. It is noted that the term “when” herein shall be understood as “during a period of time”. In this way, the assistance information may be properly transmitted.

It is noted that during at least one on period of the multiple on periods, the transmitter may be configured to transmit a combination of the high-frequency optical signal and one or more dummy optical signals.

FIG. 3 shows examples of an optical signal transmitter 310 and an optical signal receiver 330 according to this disclosure. In FIGS. 1-3, corresponding elements may share the same features and function likewise.

The optical signal transmitter 310 in FIG. 3 may be a movable (or mobile) terminal. The optical signal receiver 330 in FIG. 3 may be an OW AP. The optical signal transmitter 310 is configured to transmit a hybrid optical signal 301 as illustrated in FIGS. 1-2. In this disclosure, an uplink channel refers to a communication channel transmitting data from the optical signal transmitter 310 to the optical signal receiver 330; a downlink channel refers to a communication channel transmitting data from the optical signal receiver 330 to the optical signal transmitter 310.

The optical signal receiver 330 is configured to receive the hybrid optical signal 301, e.g., in an uplink channel. The hybrid optical signal 301 comprises low-rate assistance information carried in a low-frequency signal and high-rate data carried in a high-frequency signal. The low-frequency signal is represented by the on-off pattern (or the envelop) 302 of the hybrid signal 301; the high-frequency signal is the signal 303 received by the optical signal transmitter 310 during each on period.

The optical signal receiver 330 comprises at least one image sensor 331 for determining the on-off pattern and at least one light detector for receiving a high-frequency optical signal. For determining the on-off pattern, the image sensor is configured to first detect such a high-frequency optical signal 301 transmitted from the optical signal transmitter 310. It is noted that the term “detect” shall be understood as “capture” or “determine the existence of”. The term “receive” shall be understood as “obtain and determine the content of”.

Due to the limited frame rate of the image sensor 331, the image sensor 331 can at best detect (or capture) there is an optical signal (i.e., the hybrid signal 301) transmitted from the optical signal transmitter 310. However, the image sensor 331 cannot properly determine the content (e.g. data) carried in the optical signal, since an optical signal usually is at a high frequency (much higher than the frame rate). According to this disclosure, the hybrid signal 301 comprises multiple on periods and multiple off periods. Thus, the image sensor is configured to determine the on-off pattern by trying to detect whether there is a high-frequency optical signal transmitted during a certain period of time (e.g., with a length of T_s as a basic unit). In response to successfully detecting/capturing (or having detected/captured) the high-frequency optical signal during a certain period of time, the image sensor 331 may regard this period of time as one or more on periods. In response to not having detected/captured the high-frequency optical signal during a certain period of time, the image sensor 331 may regard this period of time as one or more off periods. In this way, the on-off pattern may be determined, and the low-frequency signal may be obtained. It is noted that as mentioned previously with respect to FIG. 1, the low frequency of the low-frequency signal (i.e., the second frequency) may be pre-determined or signaled in advance. That is, the low frequency may be agreed in advance between the optical signal transmitter 310 and receiver 330. Thus, the low-rate assistance information may be obtained (or decodable) by the optical signal receiver 330, e.g., according to the known low frequency. Since the low-rate assistance information comprises an ID of the optical signal transmitter 310, the terminal ID may be obtained by the optical signal receiver 330.

The optical signal receiver 330 is further configured to obtain the location information of the optical signal transmitter 310 via the image sensor 331. For example, the image sensor may be configured to capture the image of the optical signal transmitter 310. That is, the optical signal receiver 330 may employ object recognition techniques (e.g., based on machine learning techniques) to infer the location information of the optical signal transmitter 310. Alternatively, a pixel region of the image sensor where the assistance information (or the hybrid signal) is received (hereinafter, “illuminated pixels”) can be used to assist the positioning of the optical signal transmitter 310. For example, the distance and/or depth information of the pixel region may be used as additional inputs to infer the location information of the optical signal transmitter 310. The depth information of the pixel region may be referred to as a perpendicular distance from the plane of the image sensor 331 to the plane of the optical signal transmitter 310, or a vertical height between the image sensor 331 and the optical signal transmitter 310. For example, the more concentrated the illuminated pixels are, the closer the optical signal transmitter 310 might be.

Optionally, in this disclosure, the image sensor 331 may be further configured to capture sensing data associated with the high-frequency signal. Based on the sensing data (e.g., illuminated pixels, distance and/or depth information of the illuminated pixels), the optical signal receiver 330 may be configured to obtain (e.g., infer) the location information of the optical signal transmitter 310. In this way, the location information and the transmitter ID may be determined and associated based on the single hybrid signal 301.

Optionally, the optical signal receiver 330 may be further configured to obtain motion-related information of the optical signal transmitter 310 comprised in the assistance information.

Optionally, the optical signal receiver 330 may be further configured to obtain encryption key information of the optical signal transmitter 310 comprised in the assistance information, and perform encryption based on the encryption key information. The encryption key information may be, e.g., a public key of the optical signal transmitter 310. The optical signal receiver 330 may be configured to use the public key to encrypt communication or data in a downlink channel. Since the public key is provided by the optical signal transmitter 310, the optical signal transmitter 330 receiving the downlink communication may be configured to decrypt data using its own private key. In this way, encryption communication is possible based on the assistance information and the security level of the OW communication is improved.

Optionally, the optical signal receiver 330 may be further configured to obtain one or more resource requests indicating subsequence uplink data transmission(s). Therefore, the optical signal transmitter 310 can freely (flexibly) determine uplink resources on its own and only needs to indicate the corresponding resources properly to the optical signal receiver 330.

The optical signal receiver 330 further comprises at least one light detector 332 for receiving the high-frequency optical signal. After the location information of the optical signal transmitter 310 is obtained by the optical signal receiver 330, the optical signal receiver 330 may be configured to align the light detector 332 towards the location of the optical signal transmitter 310. The light detector 332 is configured to receive the high-frequency optical signal based further on the location information of the optical signal transmitter 310. In this way, line-of-sight communications may be established between the optical signal transmitter 310 and receiver 330 (including the light detector 332). In this way, the signal quality can be improved and the reliability of the OWC can be increased.

One aspect of the present disclosure also provides an optical wireless communication system 300 comprising at least one optical signal transmitter 310, e.g. as a terminal, and at least one optical signal receiver 330, e.g. as an OW AP as mentioned with respect to FIGS. 1-3.

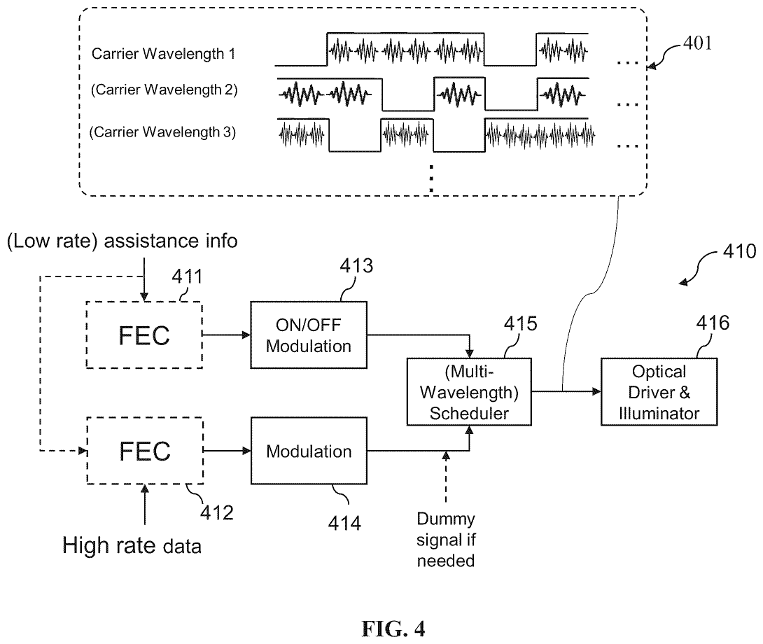

FIG. 4 shows an example of an optical signal transmitter 410 according to this disclosure. In FIGS. 1-4, corresponding elements may share the same features and function likewise. The optical signal transmitter 410 in FIG. 4 may correspond to the optical signal transmitter mentioned with respect to FIGS. 1-3.

In FIG. 4, the optical signal transmitter 410 may comprise a plurality of units adapted to function collaboratively to send a hybrid signal 401 as mentioned in FIGS. 1-3. The optical signal transmitter 410 may comprise an optional FEC unit 411, 412. FEC stands for “forward error correction”. The FEC unit 411, 412 may be adapted to perform EFC on the low-rate assistance information and on the high-rate data, respectively. This can enhance data reliability. It is noted that though the FEC unit 411, 412 is illustrated as separated units in FIG. 4, it does not imply an actual number of the FEC unit comprised in the optical signal transmitter 410. A same/single FEC unit may be adapted to process the low-rate assistance information and high-rate data.

The optical signal transmitter 410 may further comprise an on/off (ON/OFF) modulation unit 413 adapted to modulate the assistance information into an on-off (ON/OFF) pattern. The optical signal transmitter 410 may further comprise a modulation unit 414 adapted to modulate the high-rate data. Any modulation scheme suitable for modulating data for OWC can be adopted by the modulation unit 414. Then, the modulated high-rate data and low-rate assistance information may be combined by a (multi-wavelength) scheduler 415 of the optical signal transmitter 410. Optional dummy signal(s) may be inserted (or padded) into one or more of the on periods if necessary. After obtaining the hybrid signal 401, the optical signal transmitter may further comprise an optical driver and illuminator 416 configured to transmit the hybrid signal 401 by turning on/off (or brightening/dimming) relevant components accordingly.

Optionally, as illustrated in FIG. 4, the hybrid signal may comprise carriers of different wavelengths. For each carrier, the on/off pattern mentioned with respect to FIGS. 1-3 may be applied. That is, more than one high-frequency optical signal may be substantially transmitted using different wavelengths. The carriers of different wavelengths may correspond to different on-off patterns. Optionally, the optical signal transmitter 410 may be adapted to ensure that there is at least one carrier transmitting a respective high-frequency optical signal for any period of time. In this way, continuous data transmission can be ensured. The data transmission via OWC may not be substantially interrupted due to the on-off pattern.

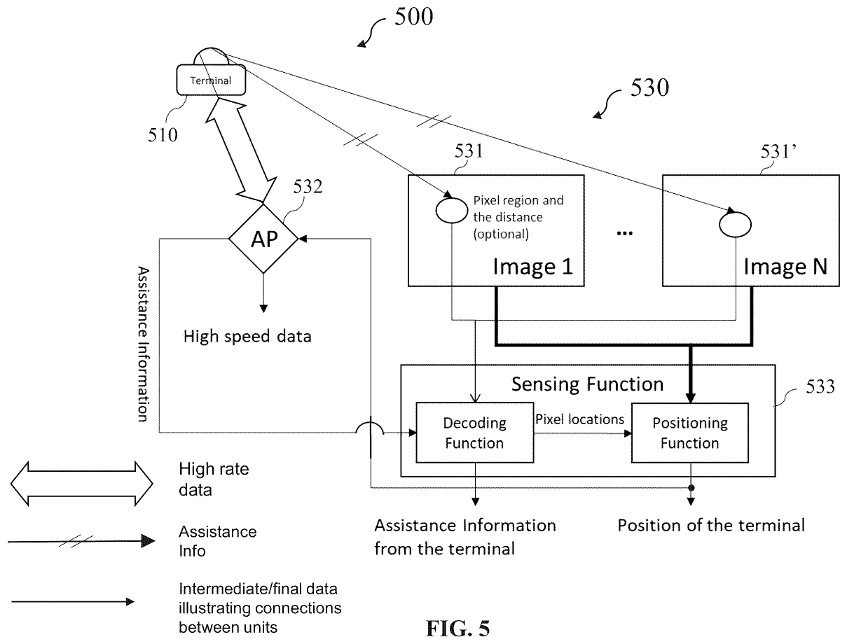

FIG. 5 shows an example of an optical signal receiver 530 according to this disclosure. In FIGS. 1-5, corresponding elements may share the same features and function likewise. The optical signal transmitter 510 in FIG. 5 may correspond to the optical signal transmitter mentioned with respect to FIGS. 1-4. The optical signal receiver 530 in FIG. 5 may correspond to the optical signal receiver mentioned with respect to FIGS. 1-4. Similar to FIG. 3, the optical signal transmitter 510 and the optical signal receiver 530 may form a system 500.

As illustrated in FIG. 5, the optical signal receiver 530 may comprise at least one image sensor (IS) 531, at least one light detector functioning as an AP 532, and an optional sensing function unit 533.

The optical signal receiver 530 may achieve integrated sensing (positioning and identification) for assisting optical wireless communication. For example, the optical signal transmitter 510 transmits the hybrid signal which can be detected by the image sensor 531 and at the same time can be received by the AP 532. The term “at the same time” used herein may be understood that the same hybrid signal can be both sensed by the image sensor 531 and the AP 532 during a same period of time. Each of the image sensor 531 and the AP 532 may obtain relevant information based on the same hybrid signal. There is no need to use separate signals to indicate assistance information and transmit high-rate data. It is noted the assistance information and the high-rate data are separately illustrated in FIG. 4 from function perspectives only, this shall not be interpreted as that the assistance information and the high-rate data are physically transmitted in separated signals. The same applies to the subsequent drawings as well.

The image sensor 531 may be configured to sense the low-frequency signal from the optical signal transmitter 510 and decode a terminal ID and other optional assistance information comprised therein (e.g. through an optional decoding function unit). Alternatively, the decoding of the terminal ID and other optional assistance information can be also done by the sensing function unit 533.

Optionally, when there is more than one image sensor 531, 531′, sensed signals from the multiple image sensors 531, 531′ can be combined at the sensing function unit 533 for enhancing the decoding performance.

Based on the sensing data from the image sensor(s) 531, the sensing function unit 533 may determine the position of the optical signal transmitter 510 (by an optional positioning function unit) and associate each transmitter's position with its transmitted assistance information (including the corresponding terminal ID). Optionally, multi-IS system may be adapted to sense the optical signal transmitter 510 in 3D utilizing parallax. Optionally, machine learning techniques can be also used for sensing (for both single IS and multi-IS).

The position(s) and ID(s) of the optical signal transmitter(s) may be further provided to a sensing application which consumes the sensing results.

The sensing function unit 533 can further provide the transmitter's position and assistance information to the AP 532. The AP 532 can make use of the position for establishing and/or maintaining a (line-of sight) communication link with an identified transmitter, such as performing beam steering based on the angular information and/or power control based on the distance information.

If the assistance information is also decodable by the AP 532, the assistance information can be provided to the sensing function unit 533 to assist the identification and positioning process for the transmitter 510. That is, optionally, when the high rate (high speed) data carries the assistance information as a copy, the AP 532 may be configured to provide the copy of the assistance information to its sensing function unit 533 (e.g., the decoding function unit) for verification (and correction if necessary).

The sensing function unit 533 may comprise the decoding (sub-) function unit and the positioning (sub-) function unit. The decoding function unit may be adapted to decode the assistance information and detect the pixel region in which the information is received. The detection of the pixel region can be assisted by object recognition techniques such as machine learning-based image recognition. The pixel region is provided to the positioning function unit which is adapted to compute the position of the transmitter 510.

Optionally, the distance or depth information from the image sensor may be used in addition to the detected pixel region by the positioning function unit to compute the position of the transmitter 510.

In this way, both the assistance information from the transmitter 510 and the location of the transmitter 510 can be obtained and associated. Meanwhile, the high-rate data carried in the hybrid signal from the transmitter 510 can be received and decoded by the AP 532 simultaneously.

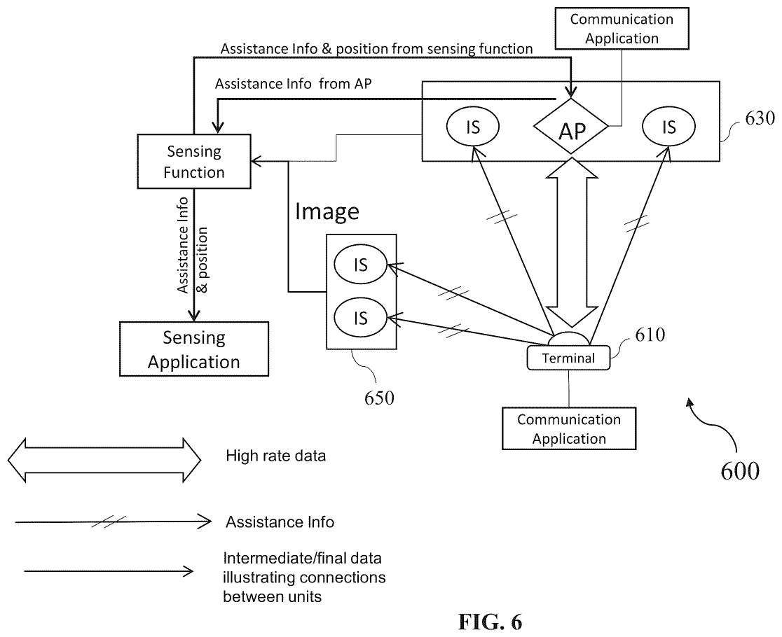

FIG. 6 shows an example of a system 600 according to this disclosure. In FIGS. 1-6, corresponding elements may share the same features and function likewise. The system 600 comprises an optical signal transmitter 610 and receiver 630. The system 600 may correspond to the system mentioned with respect to FIG. 5. The optical signal transmitter 610 in FIG. 6 may correspond to the optical signal transmitter mentioned with respect to FIGS. 1-5. The optical signal receiver 630 in FIG. 6 may correspond to the optical signal receiver mentioned with respect to FIGS. 1-5.

In addition, the system 600 may further comprise one or more further image sensors 650. The one or more further image sensors 650 may be deployed in one or more distinct locations with respect to the optical signal receiver 630.

In case that the sensing function unit is integrated inside the optical signal receiver 630, the one or more further image sensors 650 are communicable with the optical signal receiver 630. In case that the sensing function unit is remotely located in a server, one or more further image sensors 650 are communicable with the sensing function unit.

The one or more further image sensors 650 may be adapted to detect assistance information and provide one or more images to the sensing function unit. In this way, the performance of sensing can be further improved, thanks to the additional input provided by the one or more further image sensors 650.

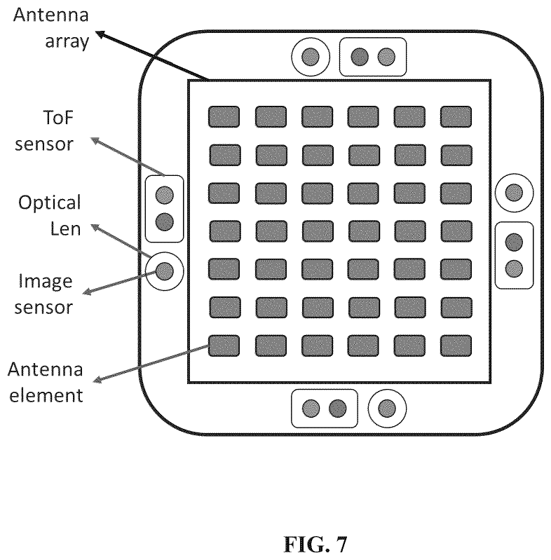

FIG. 7 shows an RF antenna array according to this disclosure.

The RF antenna array in FIG. 7 comprise one or more optical sensor groups. Each optical sensor group comprises an image sensor (with or without optical lens) and a time-of-flight (ToF) sensor. The RF antenna array may be integrated with or attached to the optical signal transmitter. The RF antenna array may be used in an RF access point. In this way, the OW and RF can be combined and integrated in a same system. The RF antenna may be adapted to use combined sensing data from the one or more optical sensor groups to enhance sensing accuracy. Each optical sensor group may track multiple terminals. In case that the image sensor is equipped with an optical lens, various types of optical lenses may be used, such as wide angle, standard and telephoto lenses for sensing different ranges, angles, and objects. Optionally, the optical lens may change the focal length to focus on a tracked object (e.g., a terminal), based on positioning. In this way, noise can be reduced, and resolution can be enhanced. This leads further to better recognition and positioning.

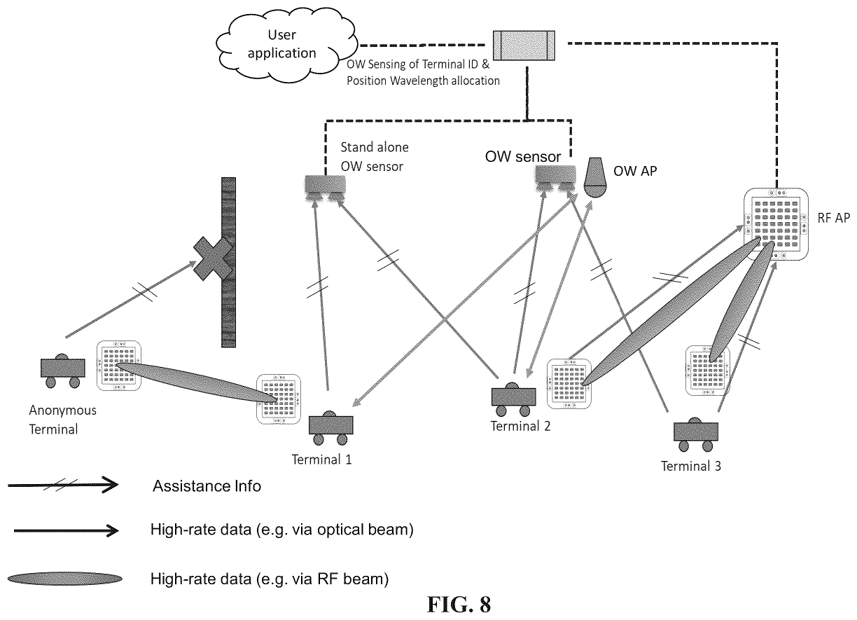

FIG. 8 shows an application scenario of this disclosure.

An example of an ISAC-OW network is depicted in FIG. 8. In the ISAC-OW network, one or more optical wireless access points (OW-APs) may be deployed to provide high-speed data link(s) (via optical communication) to one or more terminals. Optionally, the ISAC-OW may further comprise one or more RF APs that are adapted to provide RF communications to one or more terminals that are capable of RF communications. The ISAC-OW network further comprises one or more OW sensors that are adapted to perform terminal detection and positioning. The one or more OW sensors may be either co-located with the access points or not. The poisoning information determined by the OW sensors may be used to assist data communication (e.g., optical and/or RF communication) and/or may be provided to user applications where applicable.

The RF antenna array of FIG. 7 is used in FIG. 8, e.g., terminals may be equipped with an RF antenna array. In FIG. 8, various types of terminals are depicted. Terminal 1 is an optical wireless terminal that is only capable of OWC with an OW AP. Terminal 2 is a hybrid optical wireless terminal that is capable of both OWC (with the OW AP) and RF communications (with an RF AP). Terminal 3 is an RF terminal that is only capable of RF communications (with the RF AP). Terminal 3 further comprises an illumination unit adapted to transmit its assistance information to the RF AP equipped with the RF antenna array depicted in FIG. 7. It can be seen that the assistance information carried via the on-off pattern of an optical signal can be applied to Terminals 1-3. The assistance information may facilitate beam-based OW and/or RF communications.

In this way, exhaustive blind OW or RF beam search can be avoided. This can save resources and time for beam-based link establishment. Additionally, the terminal's position and the assistance information with terminal ID can be used to enhance beam tracking and power control.

Moreover, the collocated optical sensor group on the RF antenna array can enhance sensing the accuracy of positioning of multiple terminals and enables anonymous positioning without a centralized controller, e.g., between Terminal 1 and the anonymous terminal illustrated in FIG. 8.

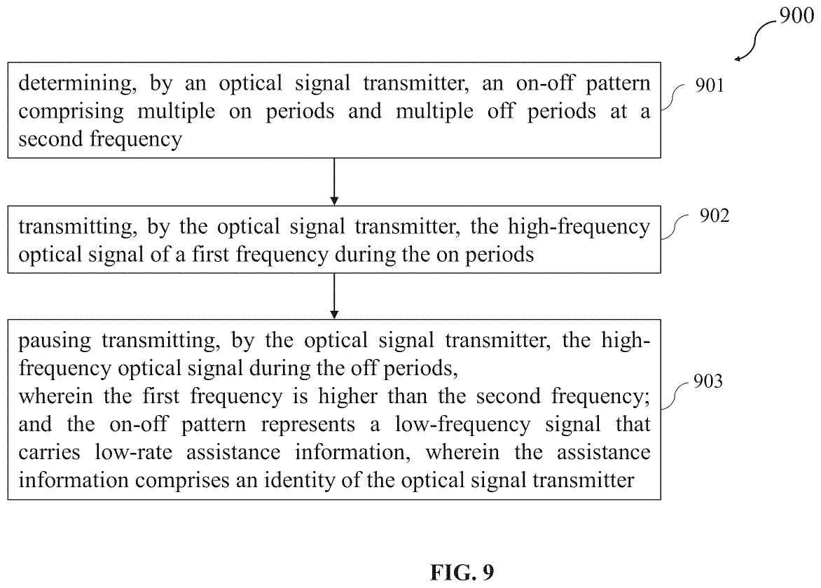

FIG. 9 shows a diagram of a method 900 according to the present disclosure.

The method 900 is executed by an optical signal transmitter mentioned with respect to FIGS. 1-8. The method 900 is for transmitting a high-frequency optical signal for an optical wireless communication system. The high-frequency optical signal carries high-rate data at a first frequency. For transmitting the high-frequency optical signal, the method comprises the following steps:
step 901: determining, by the optical signal transmitter, an on-off pattern comprising multiple on periods and multiple off periods at a second frequency;
step 902: transmitting, by the optical signal transmitter, the high-frequency optical signal during the on periods; and
step 903: pausing transmitting, by the optical signal transmitter, the high-frequency optical signal during the off periods.

The first frequency is higher than the second frequency. The on-off pattern represents a low-frequency signal that carries low-rate assistance information, in which the assistance information comprises an identity of the optical signal transmitter.

The steps of the method 900 may share the same functions and details from the perspective of the user device shown in the FIGS. 1-8 described above. Therefore, the corresponding method implementations are not described again at this point.

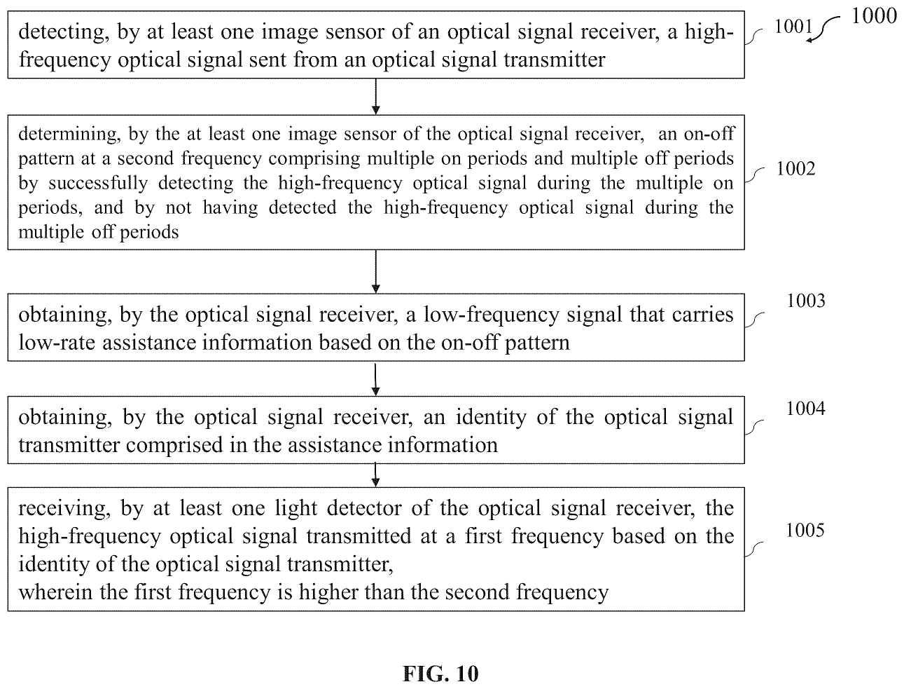

FIG. 10 shows a diagram of a method 1000 according to the present disclosure.

The method 1000 is executed by an optical signal receiver mentioned with respect to FIGS. 1-8. The method 1000 is for receiving a high-frequency optical signal for an optical wireless communication system. The method comprises the following steps:
step 1001: detecting, by at least one image sensor of an optical signal receiver, a high-frequency optical signal sent from an optical signal transmitter;
step 1002: determining, by the at least one image sensor of the optical signal receiver, an on-off pattern at a second frequency comprising multiple on periods and multiple off periods by successfully detecting the high-frequency optical signal during the multiple on periods, and by not having detected the high-frequency optical signal during the multiple off periods;
step 1003: obtaining, by the optical signal receiver, a low-frequency signal that carries low-rate assistance information based on the on-off pattern;
step 1004: obtaining, by the optical signal receiver, an identity of the optical signal transmitter comprised in the assistance information; and
step 1005: receiving, by at least one light detector of the optical signal receiver, the high-frequency optical signal transmitted at a first frequency based on the identity of the optical signal transmitter.

The first frequency is higher than the second frequency.

The steps of the method 1000 may share the same functions and details from the perspective of the user device shown in the FIGS. 1-8 described above. Therefore, the corresponding method implementations are not described again at this point.

In summary, the aspects and implementation forms of this disclosure are based on a hybrid optical signal transmitted by an optical signal transmitter, e.g., a terminal. The hybrid optical signal comprises multiple on periods and off periods. During each of the on periods, the optical signal transmitter is configured to transmit a high-frequency signal (e.g., a signal modulated with high frequency). During each of the off periods, the optical signal transmitter is configured to pause transmitting (or configured not to transmit) the high-frequency signal. The on and off periods are at a low frequency that is lower than that the frequency of the high-frequency signals. In this way, the envelope of the hybrid optical signal forms an on-off pattern at the low frequency. The on-off pattern may be used to carry low-rate data such as the low-rate assistance information, e.g., for sensing purposes. The high-frequency signal transmitted during the on periods may be used to carry communications data, e.g., for high-speed communications purposes.

In this way, a single optical signal transmitter may utilize the hybrid optical signal for both high-speed optical wireless communications and sensing. Moreover, the optical wireless sensing and communications may be unified into a single system, and there is no need to have two separate systems with redundant components for optical wireless sensing and communications, respectively.

Further, exhaustive blind optical wireless beam search can be avoided, which can save communication resources and time for beam-based link establishment. Moreover, low-rate assistance information may comprise terminal ID and the determined terminal's position can be used to enhance beam tracking and power control.

Moreover, this disclosure can also be applied to RF communications, e.g., beam-based RF communication, where a hybrid RF signal may be sent by an RF transmitter. The hybrid RF signal may, similar to the hybrid optical signal, comprise multiple on periods and multiple off periods. Other aspects of the hybrid RF signal and the RF transmitter may be similar to that of the hybrid optical signal and optical signal transmitter, and therefore, they are not repeated herein.

It is noted that each transmitter and receiver of the present disclosure (as described above) may comprise processing circuitry configured to perform, conduct, or initiate the various corresponding operations described herein, respectively. The processing circuitry may comprise hardware and software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The processing circuitry may comprise one or more processors and a non-transitory memory connected to the one or more processors. The non-transitory memory may carry executable program code which, when executed by the one or more processors, causes the device to perform, conduct or initiate the operations or methods described herein, respectively.

The present disclosure has been described in conjunction with various examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. An optical signal transmitter (310) for an optical wireless communication system, the optical signal transmitter (310) being configured to transmit a high-frequency optical signal (103) carrying high-rate data at a first frequency,
wherein the optical signal transmitter (310) is configured to determine an on-off pattern comprising multiple on periods and multiple off periods at a second frequency;
transmit the high-frequency optical signal (103) during the on periods; and
pause transmitting the high-frequency optical signal (103) during the off periods,
wherein the first frequency is higher than the second frequency; and
the on-off pattern represents a low-frequency signal (102) that carries low-rate assistance information (104), wherein the assistance information comprises an identity of the optical signal transmitter (310).

2. A method (900) for transmitting a high-frequency optical signal for an optical wireless communication system, apply to an optical signal transmitter, wherein the high-frequency optical signal carries high-rate data at a first frequency, the method comprises the following steps:
determining (901) an on-off pattern comprising multiple on periods and multiple off periods at a second frequency;
transmitting (902) the high-frequency optical signal during the on periods; and
pausing transmitting (903) the high-frequency optical signal during the off periods,
wherein the first frequency is higher than the second frequency; and
the on-off pattern represents a low-frequency signal that carries low-rate assistance information, wherein the assistance information comprises an identity of the optical signal transmitter.

3. The method according to claim 2, wherein the assistance information (104) further comprises one or more of:
motion-related information of the optical signal transmitter;
encryption key information of the optical signal transmitter; and
a resource request.

4. The method according to claim 2, wherein the method further comprises: adapt the second frequency to a sampling rate of an image sensor (331) of an optical signal receiver (330) receiving the high-frequency optical signal (103).

5. The method according to claim 2, wherein the method further comprises: transmit one or more dummy optical signals when no high-rate data is transmitted during one or more of the on periods.

6. The method according to claim 2, wherein the high-frequency optical signal further carries a copy of the assistance information (104).

7. The method according to claim 2, wherein the method further comprises: modulate the assistance information (104) based on the on-off pattern.

8. The method according to claim 2, wherein the method further comprises: transmit more than one high-frequency optical signal using carriers of different wavelengths, wherein the carriers of different wavelengths correspond to different on-off patterns.

9. The method according to claim 2, wherein the optical signal transmitter (310) is an optical wireless terminal.

10. A method (1000) for receiving a high-frequency optical signal for an optical wireless communication system, apply to an optical signal receiver, wherein optical signal receiver (330) comprising at least one light detector (332) and at least one image sensor (331), and the method comprises the following steps:
detecting (1001) a high-frequency optical signal sent from an optical signal transmitter,
determining (1002) an on-off pattern at a second frequency comprising multiple on periods and multiple off periods by successfully detecting the high-frequency optical signal during the multiple on periods, and by not having detected the high-frequency optical signal during the multiple off periods;
obtaining (1003) a low-frequency signal that carries low-rate assistance information based on the on-off pattern;
obtaining an identity of the optical signal transmitter comprised in the assistance information; and
receiving (1004) the high-frequency optical signal transmitted at a first frequency based on the identity of the optical signal transmitter,
wherein the first frequency is higher than the second frequency.

11. The method according to claim 10, wherein the method further comprises: obtain motion-related information of the optical signal transmitter (310) comprised in the assistance information (104).

12. The method according to claim 10, wherein the method further comprises: obtain encryption key information comprised in the assistance information (104), and perform encryption based on the encryption key information.

13. The method according to claim 10, wherein the method further comprises: obtain a resource request comprised in the assistance information, and receive further data based on the resource request.

14. The method according to claim 10, wherein the method further comprises: determine the second frequency based on a sampling rate of the image sensor (331).

15. The method according to claim 10, wherein the method further comprises: capture sensing data associated with the high-frequency optical signal (103);
obtain the location information of the optical signal transmitter based on the sensing data, and associate the location information with the identity of the optical signal transmitter; and
receive the high-frequency optical signal (103) based further on the location information of the optical signal transmitter.

16. The method according to claim 15, wherein the method further comprises: determine a pixel region of the image sensor (331) where the assistance information (104) is received, and determine the location information of the optical signal transmitter based further on the pixel region.

17. The method according to claim 15, wherein the method further comprises: obtain distance and/or depth information of the optical signal transmitter (310) from the image sensor (331), and determine the position of the optical signal transmitter (310) based further on the distance and/or depth information.

18. The method according to claim 10, wherein the optical signal receiver (330) is an optical wireless access point.
